(19) United States
(12) Patent Application Publication
(10) Pub. No.: US 2006/0068726 A1
(43) Pub. Date: Mar. 30, 2006

(54) Transmitter and radio communication terminal using the same

(76) Inventor: Taizo Yamawaki, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/210,734

(22) Filed: Aug. 25, 2005

(30) Foreign Application Priority Data
Aug. 26, 2004 (GB) 0419073.2

(51) Int. Cl. H01Q 11/12

(52) U.S. Cl. 455/126; 455/114.2; 455/260

(57) ABSTRACT

A radio communication terminal is provided, in which the noise reduction and the cost reduction of a dual-mode transmitter handling two types of modulation systems of a non-constant amplitude modulation and a constant amplitude modulation can be realized. By applying a phase synchronization loop to the output signal of an orthogonal modulator and a synchronization loop to an envelope, a low-noise transmitter adapted to the constant amplitude modulation and the non-constant amplitude modulation is realized. Moreover, by preparing a variable gain amplifier for realizing the envelope modulation and a variable gain amplifier for realizing the output power control of a power amplifier, it becomes possible to use a general purpose PA with a fixed gain, and therefore, the cost reduction of the radio communication terminal can be achieved.

### CROSS-REFERENCE TO RELATED APPLICATION

The present application claims priority from UK Patent Application No. GB 0419073.2 filed on Aug. 26, 2004, and U.S. patent application Ser. No. 10/509,753 filed on Sep. 30, 2004, the contents of which are hereby incorporated by reference into this application.

### TECHNICAL FIELD OF THE INVENTION

The present invention relates to a technique effectively applied to a transmitter which is adapted to the dual mode of a constant amplitude modulation and a non-constant amplitude modulation and is capable of reducing the output noise.

### BACKGROUND OF THE INVENTION

According to the examination by the inventors of the present invention, the following techniques are known in the field of a transmitter and a radio communication terminal using the same.

For example, during the past ten years, the number of subscribers of the mobile communications centered on the voice service has been explosively increasing. As such a communication system, a GSM (Global System for Mobile Communications) is known. On the other hand, needs not only for the voice service but also for high-speed data communications have been increasing in recent years, and even in the GSM system, a transition from a system using the conventional GMSK (Gaussian Minimum Shift Keying) modulation, which is the constant amplitude modulation, to an EDGE (Enhanced Data for Global Evolution) system using an 8-PSK (phase Shift Keying) modulation, which is a multiple modulation and the non-constant amplitude modulation, has been scheduled. It is indispensable that the terminal adapted to this EDGE system should be a dual-mode terminal adapted to the two systems of the conventional GSM system (constant amplitude GMSK modulation) and the EDGE system (non-constant amplitude 8-PSK modulation).

Note that the details of the above-described modulation systems of the mobile communication and the operation thereof are disclosed in, for example, Behzad Razavi, “RF Transmitter Architectures and Circuits”, IEEE 1999 Custom Integrated Circuits Conference, pp. 197 to 204.

### SUMMARY OF THE INVENTION

Incidentally, with regard to the above-described transmitter and the radio communication terminal using the same, the examination conducted by the inventors of the present invention has revealed the followings.

For example, as a transmission system used in the GSM system, a dual IF system is known. FIG. 10 is a block diagram showing a configuration of a representative transmitter in the technique examined as a premise of the present invention. The transmitter of the dual IF system consists of an orthogonal modulator (hereinafter, referred to as MOD) 100, a low pass filter (hereinafter, referred to as LPF) 101a, a mixer 102a, a band pass filter (hereinafter, referred to as BPF) 103, an intermediate frequency voltage control oscillator (hereinafter, referred to as IFVCO) 105, a frequency divider 104a, an RF frequency voltage control oscillator (hereinafter, referred to as RFVCO) 106, and a frequency divider 104b.

In this transmitter, the MOD 100 converts a center frequency of baseband signals I and Q into a first carrier wave frequency. The mixer 102a converts its output frequency into a desired frequency by using a second carrier wave. The first carrier wave frequency is generated by using the IFVCO 105 and the frequency divider 104a. The second carrier wave is generated by using the RFVCO 106 and the frequency divider 104b. The RFVCO 106 and the IFVCO 105 have the output frequency stabilized usually by using a synthesizer. In order to reduce the noises and unnecessary signals generated from circuits, the LPFs 101a and 103 are used.

Further, as another transmission system used in the GSM system, an offset PLL system is known. FIG. 11 is a block diagram showing a configuration of the representative transmitter thereof in the technique examined as the premise of the present invention. Similar to FIG. 10, the transmitter of the offset PLL system consists of the MOD 100, the LPF 101a, the IFVCO 105, the frequency divider 104a, the RFVCO 106, the frequency divider 104b, a phase comparator (hereinafter, referred to as PD) 200, an LPF 101b, a voltage control oscillator (hereinafter, referred to as TXVCO) 201, a mixer 102b and an LPF 101c.

In this transmitter, a modulation signal of the output of the LPF 101a is inputted to the PD 200 as a reference signal. The TXVCO 201 is a voltage control oscillator for outputting a desired transmission frequency. The mixer 102b converts its output frequency into a desired frequency by using the second carrier wave, and the output signal is inputted to the PD 200 as a feedback signal. The PD 200, the LPF 101b, the TXVCO 201, the mixer 102b, and the LPF 101c form a phase feedback loop (hereinafter, referred to as PM loop), which is controlled so that the frequencies and phases of the reference signal and the feedback signal inputted to the PD 200 become equal to each other. Since the feedback loop functions as the band pass filter of a narrow-band for the input signal of the PD 200, it is easy to reduce the noise of its output, that is, the output of the TXVCO 201.

In the example of the above-described dual IF system, the dual IF system can be adapted to both of the GSM system and the EDGE system if the circuit configuration is designed to be sufficiently linear. However, since it employs a system of converting the frequency in two steps, it requires frequency conversion circuits (MOD 100 and mixer 102a) and carrier wave generation circuits (frequency dividers 104a and 104b, IFVCO 105, and RFVCO 106) which make a loud noise, and therefore, it is difficult to reduce the noise in the output of the transmitter. Consequently, in the system such as the GSM which has a strict specification of noise (−162 dBc/Hz at 20 MHz detuning from the transmission frequency), a SAW (Surface Acoustic Wave) filter which is difficult to be integrated into an IC is required for the output of the mixer 102a or for the input and output of the mixer 102a, which causes the problem of the increase of the area and the cost of the terminal.

On the other hand, in the example of the above-described offset PLL system, the utilization of the narrow-band pass characteristics of the feedback loop makes it possible to reduce the noise without using the SAW filter. However, since the TXVCO 201 is an oscillator and the output amplitude of the oscillator is usually constant, the offset PLL system is applicable to the GSM system using the constant amplitude GMSK modulation but not applicable to the EDGE system using the non-constant amplitude 8-PSK modulation.

An object of the present invention is to solve the above-described problems and achieve the noise reduction of the dual-mode transmitter handling the two modulation systems of the non-constant amplitude modulation and the constant amplitude modulation without using the SAW filter which is difficult to be integrated into an IC. Further, another object of the present invention is to provide a low-cost radio communication terminal by making it possible to use a general purpose PA as a power amplifier connected to the output of the transmitter and giving a desired antenna output power regulated by communication standards to the output signal of the transmitter.

The above and other objects and novel characteristics of the present invention will be apparent from the description of the specification and the accompanying drawings.

The outline of the representative one of the inventions disclosed in this application will be simply described as follows.

That is, in order to solve the above-described problems, the present invention realizes a low-noise transmitter adapted to the constant amplitude modulation and the non-constant amplitude modulation by applying not only the PM loop but also a feedback loop to an envelope (hereinafter, referred to as AM loop) to the output signal of the MOD. Moreover, it becomes possible to use a general purpose PA with a fixed gain by preparing a variable gain amplifier (hereinafter, referred to s VGA) for the envelope modulation and a variable gain amplifier for the output power control of a power amplifier (hereinafter, referred to as PA), respectively. The general purpose PA mentioned here is a PA used in a general way, which is a PA not having additional specific functions for the transmitter.

The effect obtained by the representative one of the inventions disclosed in this application will be briefly described as follows.

That is, according to the transmitter of the present invention, it is possible to form a low-noise transmitter adapted to the dual mode of the constant amplitude modulation and the non-constant amplitude modulation, and moreover, it is possible to realize a low-cost radio communication terminal.

### BRIEF DESCRIPTIONS OF THE DRAWINGS

FIG. 1 is a block diagram showing an example of a transmitter according to an embodiment of the present invention;

FIG. 2 is an explanatory diagram showing an example of the setting of an AM loop and a PM loop in an embodiment of the present invention;

FIG. 3 is a circuit diagram showing an example of a first VGA in an embodiment of the present invention;

FIG. 4 is a characteristic diagram showing an example of the first VGA in an embodiment of the present invention;

FIG. 5 is a circuit diagram showing another example of the first VGA in an embodiment of the present invention;

FIG. 6 is a circuit diagram showing an example of a second VGA in an embodiment of the present invention;

FIG. 7 is a block diagram showing an example of a PD in an embodiment of the present invention;

FIG. 8 is an operation timing diagram showing an example of the PD in an embodiment of the present invention;

FIG. 9 is a block diagram showing an example of a radio communication terminal using the transmitter according to an embodiment of the present invention;

FIG. 10 is a block diagram showing an example of the transmitter in a technique examined as a premise of the present invention; and

FIG. 11 is a block diagram showing another example of the transmitter in the technique examined as the premise of the present invention.

### DESCRIPTIONS OF THE PREFERRED EMBODIMENTS

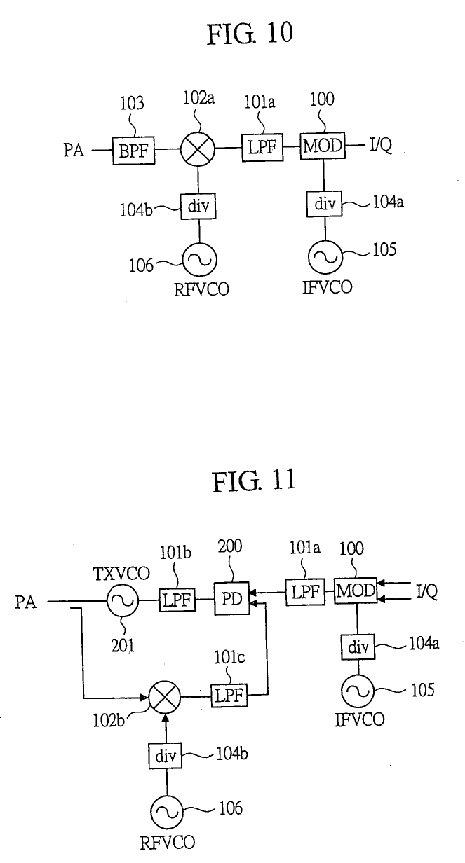

Hereinafter, embodiments of the present invention will be described in detail with reference to the accompanying drawings. Note that components having the same function are denoted by the same reference symbols throughout the drawings for describing the embodiment, and the repetitive description thereof will be omitted. This is true of the same components as those described in FIGS. 10 and 11.

In the description of an embodiment of the present embodiment, a GSM system using a GMSK modulation as a constant amplitude modulation and an EDGE system using an 8-PSK modulation as a non-constant amplitude modulation are used, respectively. However, it is needless to say that an actual execution of the embodiment is not limited to these communication systems.

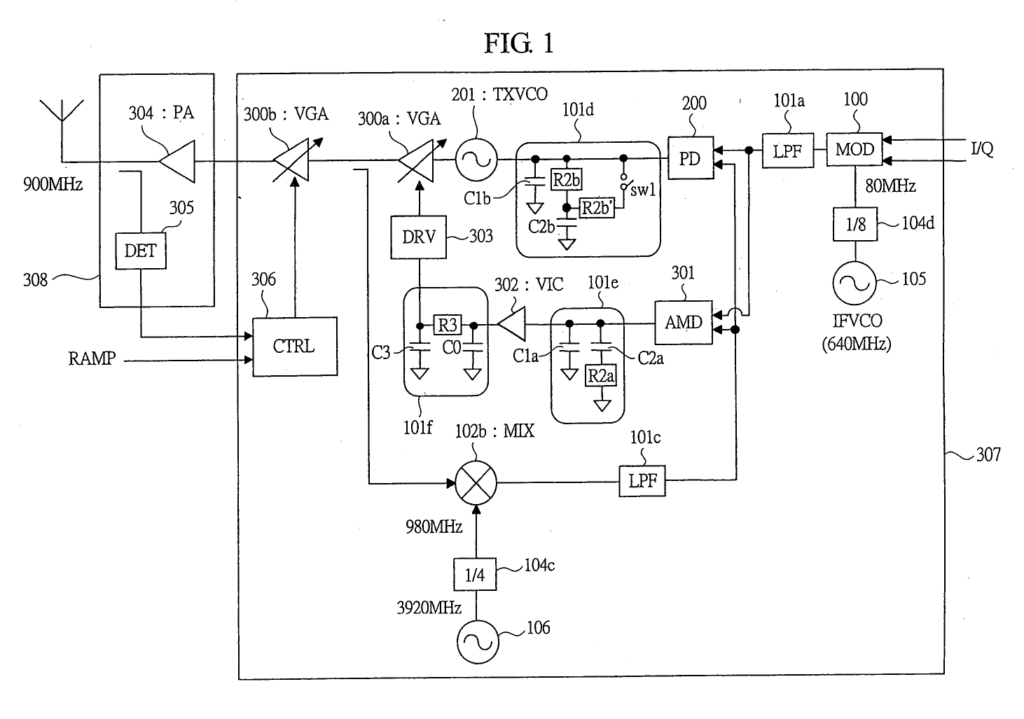

First, an example of a transmitter according to an embodiment of the present invention will be described with reference to FIG. 1. FIG. 1 is a block diagram showing an example of the transmitter according to this embodiment.

The transmitter of the present embodiment consists of: a first carrier wave frequency generating circuit composed of an MOD 100, an LPF 101a, an IFVCO 105, and a 1/8 frequency divider 104d; a second carrier wave frequency generating circuit composed of an RFVCO 106 and a 1/4 frequency divider 104c; a PM loop composed of a PD 200, an LPF 101d, a TXVCO 201, a VGA 300a, a mixer 102b, and an LPF 101c; an AM loop composed of an envelope comparator (hereinafter, referred to as AMD) 301, an LPF 101e, a voltage current converter (hereinafter, referred to as VIC) 302, an LPF 101f, a driver circuit 303 for driving a control terminal of the VGA 300a (hereinafter, referred to as DRV), the VGA 300a, a mixer 102b, and an LPF 101c; a VGA 300b; a PA 304; a detector (hereinafter, referred to as DET) 305 of the output signal of the PA 304; and a control circuit (hereinafter, referred to as CTRL) 306.

In this transmitter, the circuits surrounded by a solid line 307 is integrated into an IC, and the circuits surround by a solid line 308 is integrated into a module.

The LPF 101d consists of a switch (hereinafter, referred to as SW) 1, resistors R2b and R2b′, and capacitors C1b and C2b. The SW 1 is used in an open state at the time of the non-constant amplitude modulation operation and in the short-circuit state at the time of a constant amplitude modulation operation so as to change the frequency band of the LPF 101d. The LPF 101e consists of a resistor R2a and capacitors C1a and C2a. The LPF 101f consists of a resistor R3 and capacitors C0 and C3.

Particularly, in the configuration of the transmitter of this embodiment, the PM loop is synchronized with the phase of a reference signal and the AM loop is synchronized with an envelope of the reference signal, and an output signal is formed by the combination of the phase information and the envelope information synchronized with the reference signal, and also, the PM loop is shared in both the case of a constant envelope modulation of the reference signal and the case of a non-constant envelope modulation of the reference signal. Furthermore, the PM loop has the VGA 300a for combining the phase information and the envelope information and the VGA 300b for controlling the average power of the output signal, and the VGA 300a is connected to the inside of the PM loop and the AM loop and the VGA 300b is connected to the outside of the PM loop and the AM loop. The VGA 300a consists of a self-biased inverter circuit. Also, the PM loop has the PD 200 for executing a phase comparison between the reference signal and a feedback signal, and the PD 200 consists of an analog phase comparator and a digital phase comparator.

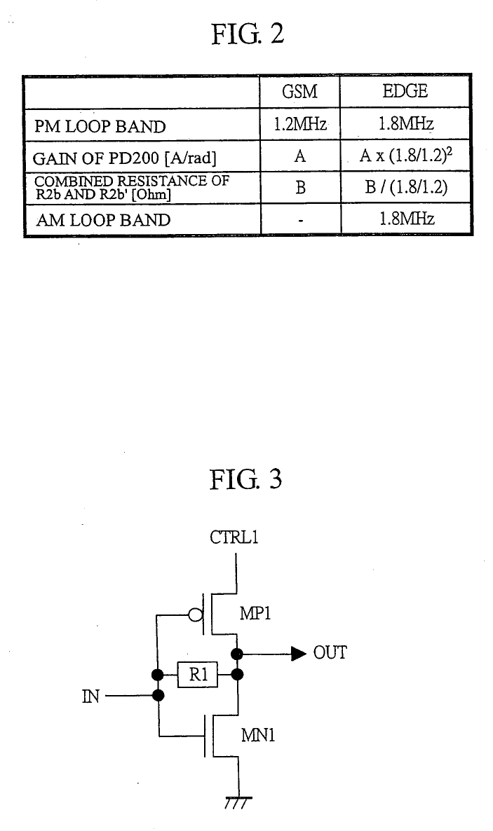

Next, an example of the operation by each of the modulation systems of the non-constant amplitude modulation and the constant amplitude modulation in the transmitter of this embodiment will be described with reference to FIGS. 1 and 2. FIG. 2 is an explanatory diagram showing an example of the setting of an AM loop and a PM loop.

First, the operation in the case of using the non-constant amplitude modulation (EDGE) as I and Q baseband signals will be described.

The I and Q baseband signals are converted into a signal having a first carrier wave frequency as a center frequency in the MOD 100, and unnecessary signals are suppressed by the LPF 101a. The output signal of the LPF 101a becomes a reference input signal of the PD 200 and the AMD 301.

By the PM loop, the phases and the frequencies of the reference input signal and the feedback input signal to the PD 200 are controlled to be equal to each other, and as a result, the phase or the frequency modulation component included in the reference input signal is reproduced in the output of VGA 300a, and the center frequency is converted into a frequency determined by the first and second carrier wave frequencies. For example, when the output frequency of the IFVCO 105 is 640 MHz, the first carrier wave frequency becomes 80 MHz and the center frequency of the reference input signal becomes 80 MHz. Consequently, the center frequency of the feedback signal toward the PD 200 becomes 80 MHz. On the other hand, when the frequency of the RFVCO 106 is set to 3920 MHz, the second carrier wave frequency becomes 980 MHz. Since the result of the down conversion of the center frequency of the output of the VGA 300a by the mixer 102b becomes 80 MHz, the center frequency of the output of the VGA 300a becomes 900 MHz eventually.

Similarly, the reference input signal and the envelope of the feedback input signal toward the AMD 301 are controlled to be equal to each other by the AM loop, and as a result, the envelope included in the reference input signal is reproduced in the output of the VGA 300a. However, the circuit included in the AM loop is designed to be sufficiently linear so that the envelope is faithfully reproduced in the output of the VGA 300a.

As described above, the PM loop has a narrow-band pass filter characteristic for the input signal of the PD 200. Moreover, the AM loop also has the narrow-band pass filter characteristic for the input signal of the AMD 301. By these two filter characteristics, the noise reduction of the transmitter can be realized.

The bandwidth of the AM loop is determined by a gain of the circuit included in the AM loop and the frequency characteristics of the LPF 101e and the LPF 101f. In the case of the EDGE, the bandwidth of the AM loop is designed to be approximately 1.8 MHz in view of the balance between the noise reduction effect of the loop and the reproduction accuracy of the envelope modulation. On the other hand, the bandwidth of the PM loop is determined by a sensitivity of the TXVCO 201, a gain of the PD 200, and a frequency characteristic of the LPF 101d. In the case of the EDGE, the bandwidth of the PM loop is designed to be also approximately 1.8 MHz in view of the noise reduction effect of the loop and a delay amount matching with the AM loop. In this case, the SW 1 of the LPF 101d is used in an open state.

Since the output signal of the TXVCO 201 is a constant envelope signal as described above, the reproduction of the envelope is realized by controlling the gain of the VGA 300a. Consequently, a variable gain range is sufficient if it covers the change of an envelope of the modulation signal, and in the case of the EDGE, the range may be approximately 18 dB, and therefore, a simple circuit can be used.

On the other hand, in the case of the GSM and the EDGE, an antenna output power is required to be variable at least 40 dB. To satisfy this requirement, the VGA 300b is used. The VGA 300b is a linear amplifier having a variable gain range of 40 dB or more. The control of the antenna output power is performed by using the DET 305 and the CTRL 306. The output power of the PA 304 is detected by the DET 305 and a detection signal is outputted. The detection signal is compared to a reference signal RAMP at the CTRL 306 and a gain control signal of the VGA 300b is generated so that the detection signal and the reference signal become equal to each other, and an antenna output power control loop is formed by the VGA 300b, the PA 304, the DET 305 and the CTRL 306. As described above, since the variable gain characteristic required for the antenna output power control is realized by the VGA 300b, it is sufficient that the PA 304 has a linear characteristic by the fixed gain. Therefore, no additional specific function is required to realize the transmitter and it is possible to use a general purpose PA. However, the characteristic of the PA 304, for example, the gain thereof sometimes changes depending on the GSM operation and the EDGE operation.

Subsequently, the operation in case of using the constant amplitude modulation (GSM) as the I and Q baseband signals will be described.

In this case, the circuits required only for the AM loop operation are set in a non-operational state. That is, they are the AMD 301 and the VIC 302. The DRV 303 operates so as to give a desired fixed potential to the VGA 300a, and as a result, the VGA 300a operates as a fixed gain amplifier. The PM loop operates in the manner as described above, and the transmitter operates similarly to the offset PLL and can output a low-noise signal. However, in the case of the GSM, an output C/N specification is severe in comparison to the EDGE, that is, approximately 6 dB, and therefore, it is necessary to reduce the output noise of the transmitter in comparison to the EDGE operation. For one thing, the noise is reduced by setting the AMD 301 and the VIC 302 to a non-operational state. Furthermore, the noise is reduced by narrowing down the PM loop band in comparison to that of the EDGE operation. Different from the case of the EDGE operation in which a delay amount matching with the AM loop is taken into consideration, at the time of designing the PM loop band, the PM loop band can be determined only in view of the balance between a noise suppression characteristic and a modulation signal reproduction accuracy, and it is designed to be approximately 1.2 MHz. In order to change the PM loop band from that of the EDGE operation time, the SW 1 of the LPF 101d is set into a short-circuit state so that the frequency band of the LPF 101d is expanded, and at the same time, the gain of the PD 200 is also changed in order to reduce the variation of the margin of the PM loop phase due to the change of the frequency characteristic of the LPF 101d.

FIG. 2 shows the design values of the AM loop and the PM loop at the time of the GSM operation and at the time of the EDGE operation. At the time of the GSM operation, the PM loop band is 1.2 MHz, the gain of the PD 200 is A, and a combined resistance of the resistors R2b and R2b′ is B. At the time of the DEGE operation, the PM loop band is 1.8 MHz, the gain of the PD 200 is A×(1.8/1.2), the combined resistance of the resistors R2b and R2b′ is B/(1.8/1.2), and the AM loop band is 1.8 MHz. Note that A and B are some desired values and the actual values thereof are determined by the TXVCO 201, the noise characteristic, and the like.

As described above, according to the transmitter of this embodiment, the key points and effects can be summed up as follows.

1. By adopting the PM loop and the AM loop for the output signal of the LPF 101a, a low-noise transmitter adapted to the constant amplitude modulation (GSM) and the non-constant amplitude modulation (EDGE) can be realized. Further, since it is possible to set the optimum PM loop band by the GSM and EDGE operations, a further low-noise transmitter can be realized. As a result, the SAW filter which is difficult to be integrated into the IC becomes unnecessary, and thus, the transmitter can be realized at low cost.

2. By using the VGA 300a to enable the non-constant amplitude modulation and the VGA 300b for realizing an output power control of the PA 304, the general purpose PA with a fixed gain can be used, and therefore, it is possible to realize the transmitter at low cost.

The circuits integrated into an IC 307 and a module 308 are not limited to the examples in the above-described embodiment, and the control circuit 306 may be integrated into the module 308 in some cases.

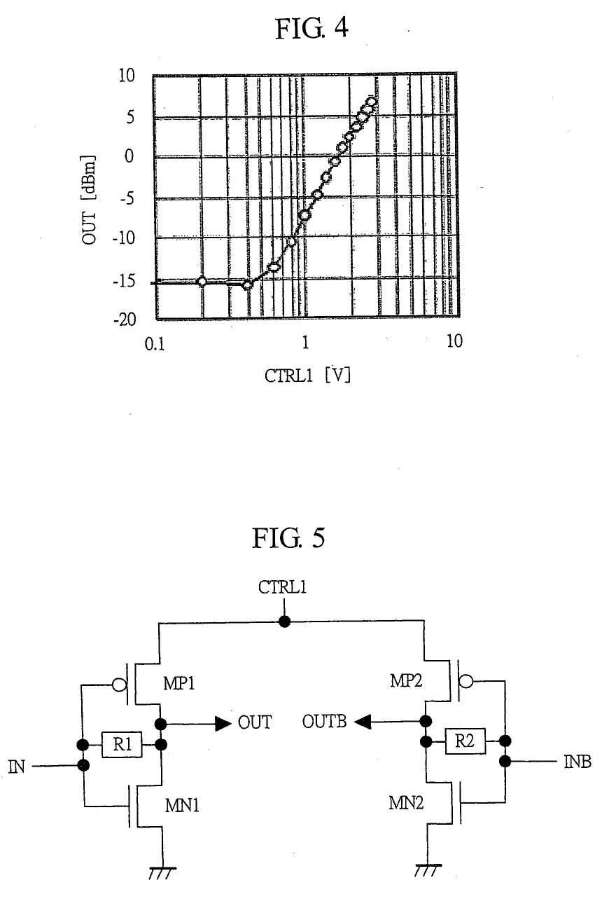

Next, an example of the VGA 300a in the transmitter of this embodiment will be described with reference to FIGS. 3 to 5. FIG. 3 is a circuit diagram showing an example of the VGA 300a. FIG. 4 is a characteristic diagram showing an example of the VGA 300a. FIG. 5 is a circuit diagram showing another example of the VGA 300a.

As shown in FIG. 3, the VGA 300a consists of a PMOS transistor MP1, an NMOS transistor MN1, and a resistor R1. The PMOS transistor MP1 and the NMOS transistor MN1 form an inverter circuit, and a self-bias is applied by the resistor R1. A gain of the VGA 300a is controlled by changing the potential applied to a CTRL1 terminal connected to the DRV 303. Since the self-bias is applied, even when the potential of the CTRL1 terminal is changed, it is possible to maintain the bias of an IN terminal and an OUT terminal always at an approximate central point between the CTRL1 potential and a ground potential. Hence, the gain can be changed linearly for a wide CTRL1 potential range, and moreover, a large gain can be given to the input signal from the IN terminal.

As shown in FIG. 4, as a result of the simulation of an output power dependence of the OUT terminal on the CTRL1 potential, it was found that the output power of the OUT terminal can be linearly increased when the CTRL1 potential is approximately 0.4 V or more.

As shown in FIG. 5, another example of the VGA 300a is characterized in that a PMOS transistor MP2, an NMOS transistor MN2, and a resistor R2 are added to the example of FIG. 3 to differentiate the circuits. A differential input signal is inputted from the IN terminal and an INB terminal and a differential output signal is outputted from the OUT terminal and an OUTB terminal. The gain is controlled by the CTRL1 potential. Compared to the example of FIG. 3, a circuit scale is increased, but an common-mode noise reduction characteristic is improved by the differential motion.

As described above, the VGA 300a inside the PM loop and the AM loop can be realized by a relatively simple circuit configuration as shown in FIGS. 3 and 5. For example, compared to the VGA 300b to be described later, which is connected to the outside of the PM loop and the AM loop, fewer number of circuit components are used and the circuit scale can be reduced. The reason is that since the VGA 300b outside the loop depends on the output power of the PA304, a variable width must be enlarged in accordance with the change of the average output power of the PA304, and on the other hand, since the VGA 300a inside the loop does not depend on the output power of the PA304, the variable width can be minimized in accordance with the constant average output power.

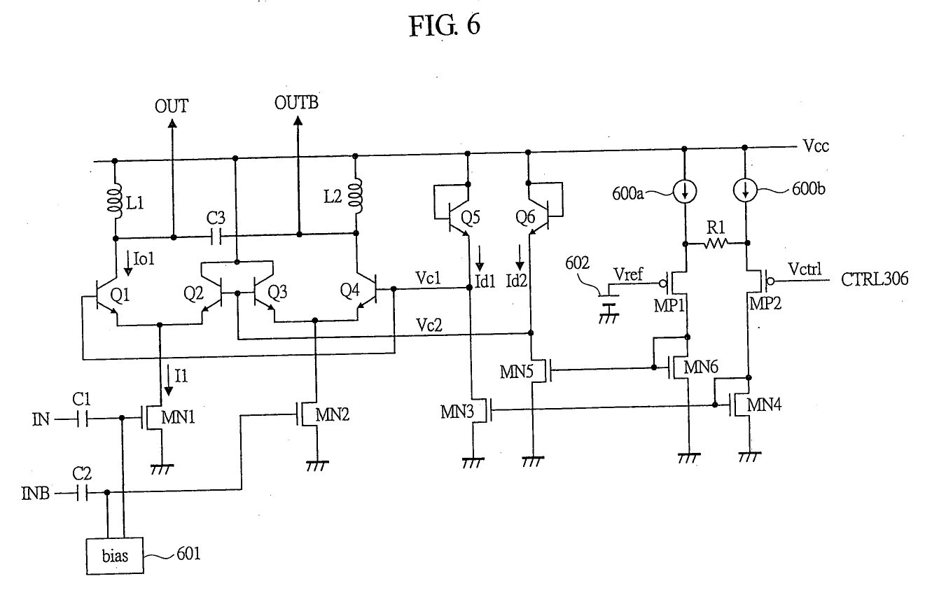

Next, an example of the VGA 300b in the transmitter of this embodiment will be described with reference to FIG. 6. FIG. 6 is a circuit diagram showing an example of the VGA 300b.

The VGA 300b consists of bipolar transistors Q1 to Q6, NMOS transistors MN1 to MN6, PMOS transistors MP1 and MP2, inductors L1 and L2, capacitors C1, C2 and C3, a resistor R1, a voltage source 602, current sources 600a and 600b, and a bias circuit (hereinafter, referred to as bias) 601. The capacitors C1 and C2 are DC cut capacitors and the bias 601 supplies a gate bias voltage to the transistors MN1 and MN2. The inductors L1 and L2 and the capacitor C3 form an LC resonant load.

The current sources 600a and 600b, the resistor R1, the transistors MP1 and MP2, and the voltage source 602 form a voltage-current conversion circuit, which converts a control voltage Vctrl inputted from the above-described CTRL 306 into a differential drain output current of the transistors MP1 and MP2. The transistors MN5 and MN6 and the transistors MN3 and MN4 form a current mirror circuit, and the differential drain output currents of the transistors MP1 and MP2 become input currents of the current mirror circuit. The output currents of the transistors MN3 and MN5 are inputted to the transistors Q5 and Q6, respectively, and potentials Vc1 and Vc2 corresponding to the output currents of the transistors MN3 and MN5 are generated.

On the other hand, the differential input signals IN and INB inputted from the VGA 300a are inputted to the gates of the transistors MN1 and MN2 through the capacitors C1 and C2 and are converted into drain output currents. The drain output current of the transistor MN1 is branched into collector output currents of the transistors Q1 and Q2, but only the collector current of the transistor Q1 is current-voltage converted in the inductor L1 and the capacitor C3 and is outputted to the above-described PA304 as an output signal OUT. How much percentage of the drain output currents of the transistor MN1 becomes a collector current of the transistor Q1 is determined depending on the potentials Vc1 and Vc2. For example, when the potential Vc1 is sufficiently large and the potential Vc2 is sufficiently small, the transistor Q2 is put into a cut-off state and the transistor Q1 is put into an on state, and all the drain output current of the transistor MN 1 becomes the collect current of the transistor Q1, and the voltage amplitude of the output signal OUT becomes the largest value. On the other hand, when the potential Vc1 is sufficiently small and the potential Vc2 is sufficiently large, the transistor Q1 is put into a cut-off state and the transistor Q2 is put into an on state, and all the drain output current of the transistor MN1 becomes the collector current of the transistor Q2, and the voltage amplitude of the output signal OUT becomes the smallest value.

With regard to the transistors MN2, Q3 and Q4, the voltage of the output signal OUTB is generated from the input signal INB by the same operation. Since the potentials Vc1 and Vc2 are determined by the control voltage Vctrl, the output signal level of the VGA 300b of this embodiment can be eventually controlled by the control voltage Vctrl.

In order to describe the relationship between the control voltage Vctrl and the output signal level of the VGA 300b more in detail, the relationship between the control voltage Vctrl and a collector output current Io1 of the transistor Q1 will be described by using the equations.

By using I1, the output current Io1 can be represented by the following equation (1).
Io1=I1/[1+exp{(Vc2−Vc1)/VT}] Equation (1)
where VT=kT/q, k is a Boltzmann constant, T is the absolute temperature, and q is an electron charge.

On the other hand, the potentials Vc1 and Vc2 can be represented by the following equations (2) and (3) by using Id1 and Id2.
Vc1=Vcc−VT·log(Id1/Is) Equation (2)
Vc2=Vcc−VT·log(Id2/Is) Equation (3)
where Is is a saturation current.

From the above equations (1) to (3), the following equation (4) can be derived.
Io1=Il·Id2/(Id1+Id2) Equation (4)

Here, since Id1+Id2 is determined by the output current values of the current sources 600a and 600b and is a fixed value, Io1 is proportional to Id2. On the other hand, since Id2 is proportional to the control voltage Vctrl, Io1 is proportional to the control voltage Vctrl, and consequently, Io1 is proportional to the control voltage Vctrl. Usually, the variable range of the output signal level which can be realized in the circuit shown in this embodiment is from 50 to 60 dB.

It should be naturally understood that the circuit configurations and a type of transistors used in the above description are only one of the examples, and they are not limited to this example and others are also available if they can realize the equivalent functions.

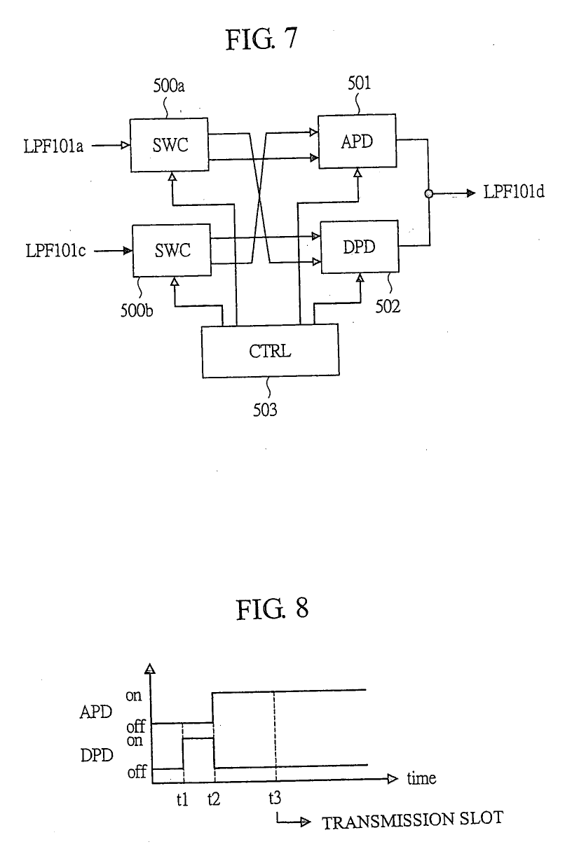

Next, an example of the PD 200 in the transmitter of this embodiment will be described with reference to FIGS. 7 and 8. FIG. 7 is a block diagram of the PD 200. FIG. 8 is a timing diagram showing an example of the PD 200.

As shown in FIG. 7, the PD 200 consists of an analog phase comparator (hereinafter, referred to as APD) 501, a digital phase comparator (hereinafter, referred to as DPD) 502, switching circuits (hereinafter, referred to as SWC) 500a and 500b, and a control circuit (hereinafter, referred to as CTRL) 503.

The SWC 500a connects the output signal of the LPF 101a to the input of the APD 501 or DPD 502 in response to the control signal from the CTRL 503. The SWC 500b connects the output signal of the LPF 101c to the input of the APD 501 or the DPD 502 in response to the control signal from the CTRL 503.

The CTRL 503 performs the control of the SWCs 500a and 500b and the control of the operation and the non-operation of the APD 501 and the DPD 502. The APD 501 has an advantage that the unnecessary output signal is small in comparison to the DPD 502, and thus, it is advantageous when faithfully reproducing the modulation signal included in a reference input signal in the output of the transmitter. However, since the capture range is narrow, there is a possibility that the convergence cannot be achieved depending on the initial convergence condition of the above-described PM loop. Hence, a control as shown in FIG. 8 is performed.

As shown in FIG. 8, at the convergence starting time (t1) of the PM loop, the output signal of the LPF 101a and the output signal of the LPF 101c are connected to the input of the DPD 502, and the DPD 502 is put into an operational state (on) and the APD 501 is put into a non-operational state (off), and then, the convergence of the PM loop is completed by using the DPD 502. After that (t2), the output signal of the LPF 101a and the output signal of the LPF 101c are connected to the input of the APD 501, and the DPD 502 is put into the non-operational state and the APD 501 is put into the operational state. At this time, the reconvergence occurs by switching from the DPD 502 to the APD 501. However, since the PM loop is once converged by using the DPD 502 within a lock range of the APD 501, there is no problem arisen. Then, after the PM loop is reconverged by using the APD 501, there comes a transmit slot timing, that is, a timing t3 for transmitting the transmit data. In the operation timing of the DPD 502 and the APD 501, the timing t2 is determined by, for example, a timer built-in the IC 307.

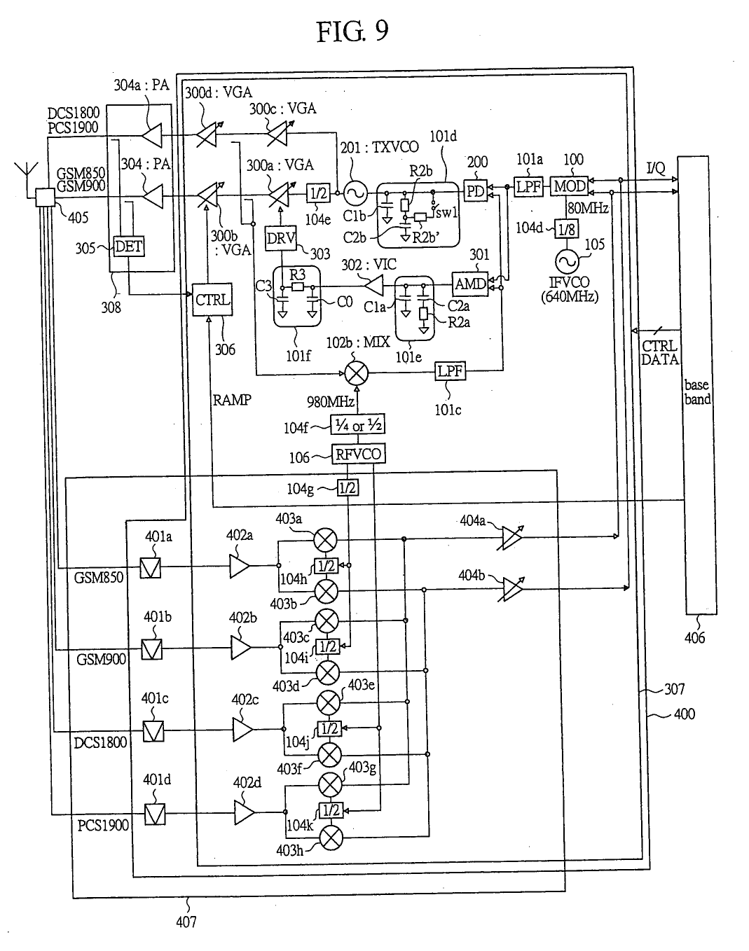

Next, an example of a radio communication terminal using the transmitter of this embodiment will be described with reference to FIG. 9. FIG. 9 is a block diagram showing an example of the radio communication terminal using the transmitter according to this embodiment.

The radio communication terminal of this embodiment is adapted to four frequency bands (GSM 850: 824 MHz to 849 MHz, GSM 900: 880 MHz to 915 MHz, DCS 1800: 1710 MHz to 1785 MHz, and PCS 1900: 1850 MHz to 1910 MHz) and two modes (GSM: GMSK modulation and EDGE: 8-PSK modulation).

In this radio communication terminal, the components surrounded by a line 307 are integrated as an IC and the components surrounded by lines 400 and 308 are integrated as modules. The reference numeral 406 denotes a baseband LSI which suitably processes a transmit data and a received data, and it inputs an I/Q baseband signal into the MOD 100 at the time of data transmission and the I/Q baseband signal is inputted thereto from the programmable gain amplifier (hereinafter, referred to as PGA) 404 of a receiver 407 at the time of data reception. Further, by transmitting the control signal (CTRL DATA) to the IC 307, a desired control is performed.

The transmitter of this radio communication terminal is a transmitter characterized by adding a 1/2 frequency divider 104e, a VGA 300c, a VGA 300d, and a PA 304a to the transmitter shown in FIG. 1 and using a frequency divider 104f functioning as both of 1/4 divider and 1/2 divider instead of the 1/4 frequency divider 104c.

In the case of the GMS 850 and GSM 900, the 1/2 frequency divider 104e, the VGA 300a, the VGA 300b, and the PA 304 are operated, and the VGA 300c, the VGA 300d and PA 304a are set into a non-operational state. Further, the frequency divider 104f is operated as the 1/4 frequency divider. Other operations are the same as those of the transmitter of FIG. 1.

In the case of the DSC 1800 and the PCS 1900, the VGA 300c, VGA 300d, and the PA 304a are operated, and the 1/2 frequency divider 104e, the VGA 300a, the VGA 300b, and the PA 304 are set into a non-operational state. Further, the frequency divider 104f is operated as the 1/4 frequency divider. Other operations are the same as those of the transmitter of FIG. 1. Further, the TXVCO 201 oscillates at 1.8 GHz band in all of the GSM 850, GSM 900, DCS 1800, and PCS 1900.

In this radio communication terminal, the components surrounded by a line 407 show a direct conversion receiver included in the radio communication terminal, which consists of SAW filters 401a to 401d, low-noise amplifiers (hereinafter, referred to as LNA) 402a to 402d, direct conversion mixers 403a to 403h, 1/2 frequency dividers 104g to 104k, and PGAs 404a and 404b capable of discretely varying the gain. The VGA type capable of continuously varying the gain is used in some cases instead of the PGAs 404a and 404b.

The received signal is inputted into a desired SAW filter 401 (401a to 401d) in accordance with the operating frequency band, and an output is outputted to a baseband LSI 406. For example, in the case of the GMS 850, the received signal is inputted into the SAW filter 401a and is transmitted to the LNA 402a, the direct conversion mixers 403a and 403b, and the PGA 404a. A local signal to be inputted to the direct conversion mixers 403a and 403b is generated by using the RFVCO 106 and the 1/2 frequency dividers 104g and 104h.

Reference numeral 405 denotes an antenna switch which connects the signal transmitted from the PA 304a or the PA 304 to the antenna at the time of the data transmission and connects the antenna to the suitable SAW filter 401 at the time of the data reception.

As described above, according to the radio communication terminal of this embodiment, the key points and effects can be summed up as follows.

More specifically, the radio communication terminal of this embodiment has the baseband LSI 406 including a baseband circuit, a transmitter to which a transmit baseband signal is inputted from the baseband LSI 406, the PAs 304 and 304a connected to the output of the transmitter, the receiver 407 outputting a received baseband signal to the baseband LSI 406, the SAW filter 401 which is a band pass filter connected to the input of the receiver 407, the antenna, the antenna switch 405 which is a selector to which the antenna, the input of the SAW filter 401 and the output of the PA 304 are connected, the RFVCO 106 which is a local signal generating circuit for supplying a local signal to the transmitter and the receiver, and the frequency dividers 104g and 104h, wherein the baseband LSI, the transmitter, the PA, the receiver, the SAW filter, the antenna, the RFVCO and the frequency divider can perform the function adapted to four frequency bands and two modes.

Note that the frequency bands and the modes are not limited to four frequency bands and two modes, and it is natural that they have the function adapted to one or other plural number of frequency bands and modes.

Further, as described above, the transmitter itself can form a low-noise transmitter adapted to a dual mode of the constant amplitude modulation and the non-constant amplitude modulation and can realize a low-cost transmitter. Therefore, it is possible to reduce the cost of the radio communication terminal.

Note that, in the radio communication terminal of this embodiment, the circuits integrated into the IC 307 and modules 308 and 400 are not limited to those in the example of FIG. 9. For example, the control circuit 306 may be integrated into the module 308 in some cases. Further, a direct conversion receiver is shown as an example of the receiver 407. However, it is not limited to this and a low IF receiver and a super heterodyne receiver are also available.

In the foregoing, the invention made by the inventors of the present invention has been concretely described based on the embodiment. However, it is needless to say that the present invention is not limited to the foregoing embodiment and various modifications and alterations can be made within the scope of the present invention.

What is claimed is:

1. A transmitter, comprising:
a first feedback loop which is synchronized with a phase of a reference signal and is controlled so that phases and frequencies of said reference signal and a feedback signal become equal to each other; and
a second feedback loop which is synchronized with an envelope of said reference signal and is controlled so that an envelope of said reference signal and an envelope of said feedback signal become equal to each other,
wherein an output signal is formed by combining the phase information synchronized with said reference signal and the envelop information synchronized with said reference signal, and
said first feedback loop is shared in both the case where said reference signal is a constant envelope modulation and the case where said reference signal is a non-constant envelope modulation.

2. The transmitter according to claim 1, comprising:
a first variable gain amplifier for combining said phase information and said envelope information; and
a second variable gain amplifier for controlling an average power of said output signal,
wherein said first variable gain amplifier is connected to the inside of said first feedback loop and said second feedback loop; and
said second variable gain amplifier is connected to the outside of said first feedback loop and said second feedback loop.

3. The transmitter according to claim 2,
wherein said first variable gain amplifier is a self bias inverter circuit and its gain control is performed by changing a potential of a power-voltage terminal of the inverter.

4. The transmitter according to claim 3,
wherein said first feedback loop has a phase comparator for performing a phase comparison between said reference signal and said feedback signal,
said phase comparator has an analog phase comparator and a digital phase comparator, and
said first feedback loop first performs a convergence by using said digital phase comparator, and then, said digital phase comparator is put into a non-operational state and said analog comparator is put into an operational state, and thereafter, the convergence is performed by using said analog phase comparator.

5. The transmitter according to claim 4,
wherein the bandwidths of either or both of said first feedback loop and said second feedback loop are controlled depending on the case where said reference signal is said constant envelope modulation and the case where said reference signal is said non-constant envelope modulation.

6. The transmitter according to claim 5,
wherein said first feedback loop has said phase comparator, a first low pass filter, a voltage control oscillator, and said first variable gain amplifier,
said second feedback loop has an envelope comparator, a second low pass filter, a voltage-current converter, said first variable gain amplifier, and a driver circuit for driving the control terminal of said first variable gain amplifier, and
said first low pass filter has a switch for changing the bandwidth of said first feedback loop depending on the case where said reference signal is said constant envelope modulation and the case where said reference signal is said non-constant envelope modulation.

7. A radio communication terminal, comprising:
a baseband circuit; a transmitter to which a transmit baseband signal is inputted from said baseband circuit; a power amplifier connected to an output of said transmitter; a receiver outputting a received baseband signal to said baseband circuit; a band pass filter connected to an input of said receiver; an antenna; a selector to which said antenna, an input of said band pass filter and an output of said power amplifier are connected; and a local signal generating circuit for supplying a local signal to said transmitter and said receiver,
wherein said baseband circuit, said transmitter, said power amplifier, said receiver, said band pass filter, said antenna, and said local signal generating circuit are adapted to one or a plurality of frequency bands and have functions adapted to one or a plurality of radio communication systems, and
said transmitter is composed of the transmitter described in claim 1.
